(19) United States
(12) Patent Application Publication
(10) Pub. No.: US 2026/0065350 A1
(43) Pub. Date: Mar. 5, 2026

(54) METHODS AND SYSTEMS FOR INTERACTIONS WITH VIRTUAL SHOPPING CART VIEW

(71) Applicant: Shopify Inc., Ottawa (CA)

(72) Inventors: Jonathan RUNDLE, London (CA); Katarina BATINA, Seattle, WA (US)

(21) Appl. No.: 18/816,396

(22) Filed: Aug. 27, 2024

(51) Int. Cl. G06Q 30/0601; G06F 3/04845; G06F 3/04886

(52) U.S. Cl. CPC G06Q 30/0633; G06F 3/04845; G06F 3/04886

(57) ABSTRACT

Methods and systems for interactions with a virtual shopping cart view are disclosed. A graphical user interface (GUI) is displayed on a touchscreen of a computing system. The GUI presents a virtual shopping cart view. The GUI also presents an edge region of an active view partially overlaid over a first side of the virtual shopping cart view. A first drag gesture is detected on the touchscreen at the edge region of the active view that moves towards an opposing second side of the virtual shopping cart view. Responsive to the first drag gesture, the GUI is caused to gradually show the active view by moving the active view over the virtual shopping cart view corresponding to movement of the first drag gesture.

### FIELD

The present disclosure relates to graphical user interfaces (GUIs), including GUIs supporting user interactions with a virtual shopping cart view.

### BACKGROUND

A typical user interface for e-commerce involves a virtual shopping cart that is used to track products a user wishes to purchase and that is used to initiate a checkout process. A virtual shopping cart view (e.g., a page or other user interface object) shows the virtual shopping cart, including any products that have been added to the virtual shopping cart. A user typically navigates between an active view (e.g., a search view, a wishlist view, a product view, an online store view, etc.) and the virtual shopping cart view. The virtual shopping cart view may be used to display a virtual shopping cart, which may be considered a state object that stores information about products selected to be purchased. An example sequence of interactions may involve the user, while on a product view, selecting a product to add to the virtual shopping cart. The user may navigate to different product views (e.g., different product pages) and select different products to add to the virtual shopping cart. When the user is ready to complete the purchase, the user may navigate to the virtual shopping cart view where they may review the products added to the virtual shopping cart and initiate the checkout process.

### SUMMARY

A user typically navigates between an active view and a virtual shopping cart view when conducting online shopping. However, it can be inefficient for a user to navigate between the active view and the virtual shopping cart view. For example, a user can unintentionally lose track of their current active view when they navigate to the virtual shopping cart view (e.g., if the active view shows search results, then selecting the “back” button from the virtual shopping cart view might inadvertently bring the user back to the query view instead). This means the user might need to repeat the navigation input (e.g., input search terms, click through views, etc.) in order to return to their desired view, resulting in wasted computing resources and a poor user experience. Further, in examples where the user is viewing pages using a browser application, there is generally an inherent overhead in resources used whenever the browser application navigates to view a new page. Thus, when a user navigates away from the active view to a virtual shopping cart view and then navigate back, overhead resources are incurred (e.g., due to the necessary computer operations of establishing a socket connection, fetching data for the virtual shopping cart, rendering the virtual shopping cart view, opening another socket connection, fetching data for the active view again, rendering the active view, etc.). Additionally, such navigation between views incurs latency, which can be significant if the user is using a computing system with a slow or poor connection.

The challenges of having to navigate to and load a virtual shopping cart view can be magnified when the virtual shopping cart view is presented on a handheld mobile device having limited screen size, limiting computing resources (e.g., limited battery life and limiting processing power) and/or lacking a keyboard or mouse. Frequently, a user may be using a handheld mobile device to carry out online shopping. A handheld mobile device (e.g., a smartphone) typically has a limited screen size (e.g., about 4-6 inches in size, measured along the diagonal of the screen) and typically has limited input mechanisms (e.g., lacking a keyboard or mouse). A user using a handheld mobile device often holds the device using one hand and interacts with the touchscreen on the device using the thumb of the same hand. In such a pose, if the current active view is lost when the user navigates to the virtual shopping cart view, re-navigation back to the desired view can be very cumbersome and frustrating. Additionally, on a handheld mobile device with limited resources (e.g., limited battery, memory, processing power), such re-navigation is a significant drain on resources (e.g., due to the overhead incurred as discussed above).

In various examples, the present disclosure provides a technical solution that provides a graphical user interface (GUI) in which a virtual shopping cart view is provided as a view underneath an active view (e.g., search view, wishlist view, online store view, etc.). A virtual shopping cart view data object is stored locally and is maintained in memory (that is, is a persistent data object) even as the user navigates to different views. This enables the virtual shopping cart view to always be accessible and viewable without having to fetch data for rendering the view from a remote server, and without having to navigate away from the active view, thus avoiding the overhead and latency discussed above. The user experience is also improved because the navigation between the active view and virtual shopping cart view becomes more seamless (e.g., reduced latency).

In various examples, the present disclosure also describes a GUI that supports the use of different touch-based inputs, enabling a more intuitive navigation between an active view and a virtual shopping cart view that is persistent underneath the active view. This provides a technical solution that improves user interactions on a handheld mobile device, for example by enabling a user to navigate between the active view and the virtual shopping cart view while holding the handheld mobile device in a one-handed pose in which touch-based inputs are provided using a thumb of the hand that is holding the device.

Examples of the present disclosure may provide technical advantages in mobile implementations as well as desktop implementations.

In an example aspect, the present disclosure describes a method performed by a computing system having a touchscreen. The method includes: displaying, on the touchscreen, a graphical user interface (GUI) presenting a virtual shopping cart view, the GUI also presenting an edge region of an active view partially overlaid over a first side of the virtual shopping cart view; detecting a first drag gesture on the touchscreen at the edge region of the active view that moves towards an opposing second side of the virtual shopping cart view; and responsive to the first drag gesture, cause the GUI to gradually show the active view by moving the active view over the virtual shopping cart view corresponding to movement of the first drag gesture.

In an example of the preceding example aspect of the method, the virtual shopping cart view may be rendered using data from a virtual shopping cart view data object stored locally on the computing system.

In an example of any of the preceding example aspects of the method, a handle user interface (UI) element may be presented in the edge region of the active view, and the first drag gesture may be detected at the handle UI element.

In an example of any of the preceding example aspects of the method, the first drag gesture may move at least a threshold distance from the first side to the second side of the virtual shopping cart view, and the GUI may present the active view fully hiding the virtual shopping cart view responsive to the first drag gesture.

In an example of any of the preceding example aspects of the method, the first drag gesture may move less than a threshold distance from the first side to the second side of the virtual shopping cart view, and the GUI may automatically move the active view back to show only the edge region after release of the first drag gesture.

In an example of the preceding example aspect of the method, the method may include: detecting a second touch input at an end of the first drag gesture; and responsive to the second touch input, cause the GUI to maintain the active view partially presented over the virtual shopping cart view.

In an example of any of the preceding example aspects of the method, the first drag gesture may move less than a threshold distance from the first side to the second side of the virtual shopping cart view, causing the active view to partially hide the virtual shopping cart view, and the active view may be maintained in place after release of the first drag gesture.

In an example of the preceding example aspect of the method, when the virtual shopping cart view is partially hidden, higher priority information on the virtual shopping cart view may be shown and lower priority information on the virtual shopping cart view may be hidden.

In an example of any of the preceding example aspects of the method, the method may include: while the GUI is presenting the active view over the virtual shopping cart view, detecting a third touch input on the touchscreen at a location corresponding to an icon of the GUI that is representative of the virtual shopping cart view; and responsive to the third touch input, cause the GUI to present the virtual shopping cart view with the edge region of the active view partially overlaid over the first side of the virtual shopping cart view.

In an example of the preceding example aspect of the method, the virtual shopping cart view may include information associated with multiple virtual shopping carts, and the GUI may be caused to automatically scroll the presented virtual shopping cart view to a particular virtual shopping cart corresponding to the active view.

In an example of any of the preceding example aspects of the method, the method may include: while the GUI is presenting the active view over the virtual shopping cart view, detecting a fourth drag gesture on the touchscreen at a location corresponding to a visual representation of a purchasable product that moves towards an icon or a handle user interface (UI) element of the GUI that is representative of the virtual shopping cart view; and responsive to the fourth drag gesture, updating the virtual shopping cart view to include an indication of the purchasable product and cause the GUI to move the active view to partially reveal the virtual shopping cart view.

In an example of the preceding example aspect of the method, the virtual shopping cart view may be partially revealed to present a portion of the virtual shopping cart view corresponding to the indication of the purchasable product.

In an example of some of the preceding example aspects of the method, updating the virtual shopping cart view may include: updating a virtual shopping cart view data object to include data associated with the purchasable product that is renderable to show the indication of the purchasable product.

In an example of any of the preceding example aspects of the method, the method may include: while the GUI is presenting the active view over the virtual shopping cart view, detecting a fifth drag gesture on the touchscreen at a location corresponding to the edge region of the active view that moves towards an opposing edge of the active view; and responsive to the fifth drag gesture, cause the GUI to gradually reveal the virtual shopping cart view by moving the active view away from the virtual shopping cart view corresponding to movement of the fifth drag gesture.

In an example of the preceding example aspect of the method, when the virtual shopping cart view is partially revealed, higher priority information on the virtual shopping cart view may be shown and lower priority information on the virtual shopping cart view may remain hidden.

In an example of any of the preceding example aspects of the method, the method may include: while the GUI is presenting the active view over the virtual shopping cart view, detecting a sixth pinch gesture on the touchscreen; and responsive to the sixth pinch gesture, cause the GUI to shrink the active view to reveal the virtual shopping cart view underneath.

In an example of any of the preceding example aspects of the method, the active view may be one of: a home view; a search view; a product view; an online store view; or a wishlist view.

In another example aspect, the present disclosure describes a computing system including a processor configured to execute computer-readable instructions to cause the computing system to: display, on a touchscreen of the computing system, a graphical user interface (GUI) presenting a virtual shopping cart view, the GUI also presenting an edge region of an active view partially overlaid over a first side of the virtual shopping cart view; detecting a first drag gesture on the touchscreen at the edge region of the active view that moves towards an opposing second side of the virtual shopping cart view; and responsive to the first drag gesture, cause the GUI to gradually show the active view by moving the active view over the virtual shopping cart view corresponding to movement of the first drag gesture.

In an example of the preceding example aspect of the computing system, the virtual shopping cart view may be rendered using data from a virtual shopping cart view data object stored locally on the computing system.

In an example of the preceding example aspect of the computing system, the instructions may cause the computing system to perform any of the preceding example aspects of the method.

In another example aspect, the present disclosure describes a non-transitory computer-readable medium storing instructions that, when executed by a processor of a computing system, cause the computing system to: display, on a touchscreen of the computing system, a graphical user interface (GUI) presenting a virtual shopping cart view, the GUI also presenting an edge region of an active view partially overlaid over a first side of the virtual shopping cart view; detecting a first drag gesture on the touchscreen at the edge region of the active view that moves towards an opposing second side of the virtual shopping cart view; and responsive to the first drag gesture, cause the GUI to gradually show the active view by moving the active view over the virtual shopping cart view corresponding to movement of the first drag gesture.

In some examples, the computer-readable medium may store instructions that, when executed by the processor of the computing system, cause the computing system to perform any of the example aspects of the method described above.

In another example aspect, the present disclosure provides a computer program including processor-executable instructions that, when executed by a processor of a computing system, cause the computing system to perform any of the example aspects of the method described above.

### BRIEF DESCRIPTION OF THE DRAWINGS

Reference will now be made, by way of example, to the accompanying drawings which show example embodiments of the present application, and in which:

FIG. 1 is a block diagram of an example computing system, which may be used to implement examples of the present disclosure;

FIGS. 2A-2D illustrate example GUIs supporting interactions with a virtual shopping cart view, in accordance with examples of the present disclosure;

FIGS. 3-4 are flowcharts illustrating example methods for interactions with a virtual shopping cart view, in accordance with examples of the present disclosure;

FIG. 5 is a block diagram illustrating an example e-commerce platform, which may be used in associated with examples of the present disclosure; and

FIG. 6 is an example administrator page, which may be provided by the e-commerce platform of FIG. 5.

Similar reference numerals may have been used in different figures to denote similar components.

### DETAILED DESCRIPTION

In various examples, the present disclosure describes methods and systems that provide a graphical user interface (GUI) in which a virtual shopping cart view is maintained as a persistent view that is accessible and viewable underneath an active view (e.g., search view, wishlist view, online store view, product view, etc.). In the present disclosure, a “view” may refer to a view rendered on the computing system to be viewable by the user, such as a page, a user interface (UI) object (in particular, a UI object that occupies a majority of the GUI) or a UI screen (not to be confused with the hardware screen of the computing system). In some examples, the virtual shopping cart view and active view may also be referred to as a virtual shopping cart page and active page. A virtual shopping cart view data object is maintained locally on a computing system (e.g., mobile handheld device, desktop device, laptop device, etc.) so that a user may access the virtual shopping cart view without having to navigate away from the active view and without having to request data from a remote server for rendering the view.

Examples of the present disclosure may be implemented on various computing systems (which may also be referred to as computing devices, computing apparatuses, etc.). The computing system may be any device capable of displaying a GUI and enabling user interactions with the GUI. For example, the computing system may be a mobile device, a handheld device, a desktop device, or a wearable device, including a smartphone, a tablet device, a laptop device, an e-reader device, a smartwatch, a smart appliance, a desktop computer, or an electronic kiosk, among others. In some examples, the computing system may support touch-based inputs (e.g., having a touchscreen or touchpad). Although some examples are described in the context of a handheld mobile device having a touchscreen (e.g., a smartphone), it should be understood that this is not intended to be limiting. Examples of the present disclosure may be implemented on a desktop device or laptop device having keyboard and/or mouse inputs, for example.

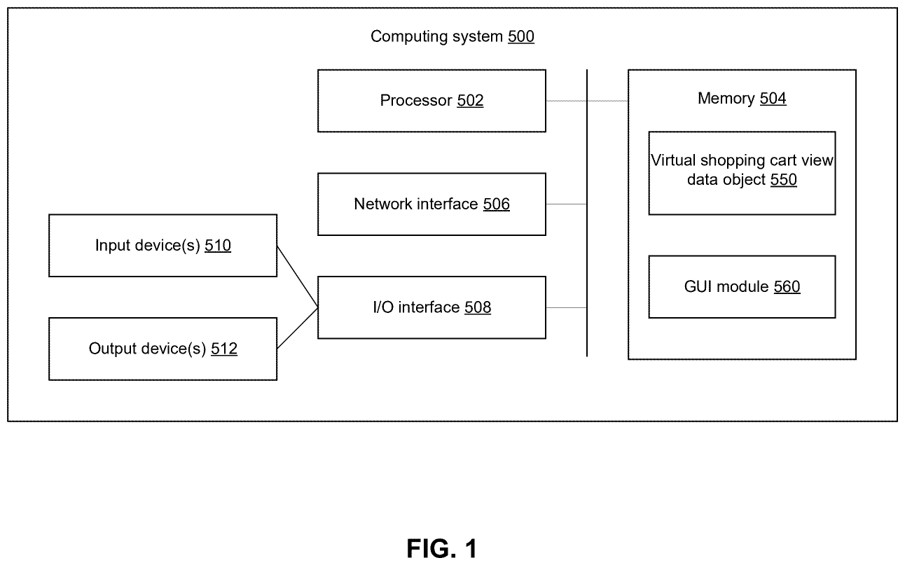

FIG. 1 illustrates an example computing system 500, which may also be referred to as a computing device or computing apparatus, which may be used to implement examples of the present disclosure. Although an example embodiment of the computing system 500 is shown and discussed below, other embodiments may be used to implement examples disclosed herein, which may include components different from those shown. The computing system 500 may be any suitable computing system as discussed above. Although FIG. 1 shows a single instance of each component, there may be multiple instances of each component shown.

The example computing system 500 includes at least one processing unit and at least one physical memory 504. The processing unit may be a hardware processor 502 (simply referred to as a processor 502). The processor 502 may be, for example, a central processing unit, a microprocessor, a digital signal processor, an application-specific integrated circuit (ASIC), a field-programmable gate array (FPGA), a dedicated logic circuitry, a graphics processing unit (GPU), a hardware accelerator, or combinations thereof. The memory 504 may include a volatile or non-volatile memory (e.g., a flash memory, a random access memory (RAM), and/or a read-only memory (ROM)). The memory 504 may store instructions for execution by the processor 502, to cause the computing system 500 to carry out examples of the methods, functionalities, systems and modules disclosed herein. The memory 504 may also store data, such as images, text, data objects, etc. For example, the memory 504 may store a virtual shopping cart view data object 550 and instructions for executing a GUI module 560, as discussed further below.

The computing system 500 may also include at least one network interface 506 for wired and/or wireless communications with an external system and/or network (e.g., an intranet, the Internet, a P2P network, a WAN and/or a LAN). The network interface 506 may enable the computing system 500 to carry out communications (e.g., wireless communications) with systems external to the computing system 500, such as a remote server storing data for a virtual shopping cart or storing data for an online product view.

The computing system 500 may include at least one input/output (I/O) interface 508, which may interface with input device(s) 510 and output device(s) 512. Input device(s) 510 may include, for example, buttons, a microphone, a touchscreen, a touchpad, a keyboard, etc. Output device(s) 512 may include, for example, a display, a speaker, etc. In this example, input device(s) 510 and output device(s) 512 are shown as internal components of the computing system 500. In other examples, one or more of the input device(s) 510 and/or output device(s) 512 may be external to the computing system 500. The input device(s) 510 may include at least one device that enables a user to provide inputs for interacting with a GUI as disclosed herein (e.g., a touchscreen for touch-based inputs, or a mouse for mouse-based inputs), and the output device(s) 512 may include at least one display device for outputting (e.g., displaying) the GUI as disclosed herein. In some examples, a single component may serve as both an input and output device (e.g., a touchscreen may detect touch inputs as well as providing display outputs).

A computing device or computing system, such as the computing system 500 of FIG. 1, may access a remote system (e.g., a remote server) to retrieve data for rendering a view (in some examples where a view is a page rendered on a browser application, this may be commonly referred to as “fetching a page”). The computing system 500 may establish a network connection with the remote system using the network interface 506. The computing system 500 may execute instructions of a browser application or other software application, for example, which initiates a socket connection (e.g., using an Internet Protocol) and uses an application programming interface (API) to communicate with the remote system to retrieve the data. In some examples, the computing system 500 may provide data, such as a pointer, to the remote system in order to retrieve the desired data.

As mentioned above, in some examples a user may interact with a GUI, displayed via a display device of the computing system 500, via touch-based inputs. A touch-sensitive device on the computing system 500 may generate touch data in response to detecting a touch, for example a touchscreen may include one or more touch-sensitive devices to detect a user's finger (or other touch effector) touching or close to touching a touchscreen. Examples of suitable touch-sensitive devices include capacitive touch-sensitive devices, resistive touch-sensitive devices, infrared touch-sensitive devices and surface acoustic wave (SAW) touch-sensitive devices, among others. A touch-sensitive device may include an array of sub-units, for example, to enable detection of touch input over an area, including detection of touch input that travels (i.e., changes location) over time (e.g., a drag gesture or a swipe gesture). Further, the touch-sensitive device may enable detection of parameters of the touch input, such as the speed, distance, direction and/or acceleration as the touch input travels. The touch data may be provided to the processor 502, via the I/O interface 508, in real-time or near real-time. In some examples, a touch-sensitive device may detect touch input without requiring physical contact, for example a capacitive touch-sensitive device may detect touch input when a conductive touch effector (such as a user's finger) is in close proximity to a touchscreen surface even without physical contact being made. In the present disclosure, references to detecting a touch should be understood to encompass detection of a touch that involves physical contact with a touchscreen as well as detection of a touch that is in close proximity to but not in physical contact with the touchscreen.

The I/O interface 508 may perform preprocessing operations on the touch data, for example normalization, filtering, denoising, etc., prior to providing the touch data to the processor 502. The touch data may represent a static touch input (e.g., where the location and/or type of the detected touch is substantially unchanged from the time the touch is detected to the time the touch is no longer detected) or a dynamic touch input (e.g., where the location and/or type of the detected touch is substantially changed from the time the touch is detected to the time the touch is no longer detected).

To help in understanding the present disclosure, a discussion of some example, non-limiting touch gestures is provided. Touch-based inputs include tap gestures, press gesture, drag gestures, swipe gestures and pinch gestures, among others. A tap gesture may be detected when the touch input is relatively short in time duration (e.g., less than 500 ms) and does not change location. A tap gesture may be detected as a double-tap gesture if two tap gestures are detected within a short time of each other (e.g., within 500 ms) at approximately the same location. A press gesture may be detected when a touch input is detected over a relatively long time duration (e.g., more than 500 ms) and remains substantially unchanged in location. In some examples, a pressure sensor may also be used to detect or confirm a press gesture when the touch input is detected at the same time pressure input is detected. A drag gesture may be detected when a touch input is detected over a relatively long time duration (e.g., more than 500 ms) and the location of the touch moves over time. A drag gesture may be associated with a speed and direction (or velocity) of the gesture. A swipe gesture may be detected when a touch input is detected over a relatively long time duration (e.g., more than 500 ms) and the touch input is moving when the touch is released. A swipe gesture may be distinguished from a drag gesture by the speed of the gesture at the time the gesture ends (e.g., a drag gesture may slow down and/or stop towards the end of the gesture whereas a swipe gesture may have a non-zero speed throughout the entire gesture). A swipe gesture may be detected when the touch input has a speed that exceeds a defined threshold (e.g., faster than a drag gesture). A pinch gesture may be detected when touch input is detected at two locations simultaneously and the two touches move towards each other.

It should be understood that the processing of touch-based inputs described herein may be equivalently implemented using non-touch-based inputs such as mouse inputs. For example, a mouse click event may be processed similar to a tap gesture; a double click event may be processed similar to a double-tap gesture; a mouse button down event may be processed similar to a press gesture; a mouse button down event followed by a mouse pointer move event may be processed similar to a drag gesture; a mouse button down event followed by a mouse pointer move event may be processed similar to a swipe gesture when the pointer movement exceeds a speed threshold; and a mouse button down event that is detected at a resize element of the GUI followed by a mouse point move event may be processed similar to a pinch gesture.

A virtual shopping cart view data object 550 is maintained by the computing system 500. The virtual shopping cart view data object 550 may be a data structure that stores includes data for one or more virtual shopping carts (each of which may be a respective data object, nested within the virtual shopping cart view data object 550, that stores information about products intended for purchase). The virtual shopping cart view data object 550 may additionally include data for rendering user interface (UI) elements on the virtual shopping cart view, such as for rendering a checkout button, in addition to data for the one or more virtual shopping carts.

In some examples, the virtual shopping cart view data object 550 may be pointer to a remotely stored data structure. Notably, the virtual shopping cart view data object 550 is a persistent data object such that the virtual shopping cart view can be accessible and viewable without requiring the computing system 500 to fetch data for rendering the view as would otherwise be required for navigating to a conventional virtual shopping cart view. In some examples, the virtual shopping cart view may be accessible and viewable as a persistent view underneath the currently active view. This means that the virtual shopping cart view is not affected by the user navigating to different views and also there is no need to navigate away from the active view to view the virtual shopping cart view. The technical solution disclosed herein enables the user to view the virtual shopping cart view without having to fetch (or re-fetch) data for the virtual shopping cart view from a remote server, without having to render (or re-render) the virtual shopping cart view from the fetched (or re-fetched) data, and without having to load (or re-load) the virtual shopping cart view from the fetched (or re-fetched) data. The virtual shopping cart view data object 550 may be stored locally on the computing system 500, and the virtual shopping cart view can be fully loaded and rendered ahead of time, using operations all within the computing system 500 itself (e.g., without having to fetch data from a remote server). Rendering of the virtual shopping cart view can be performed entirely within the computing system 500, without having to contact any remote server to retrieve any data or any interface elements.

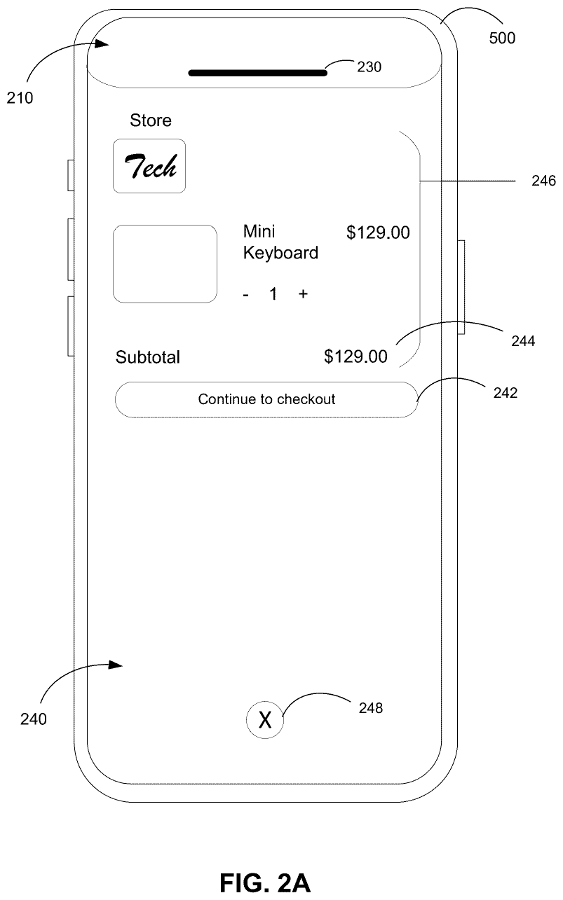

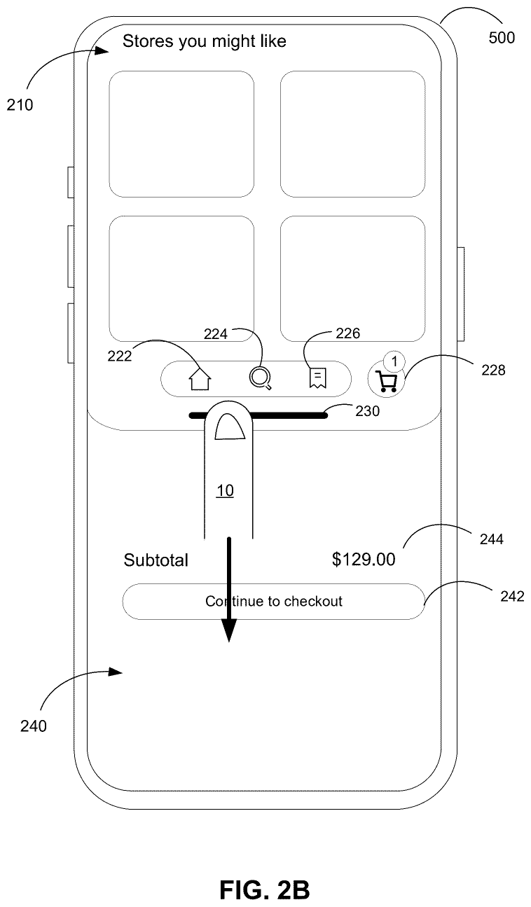

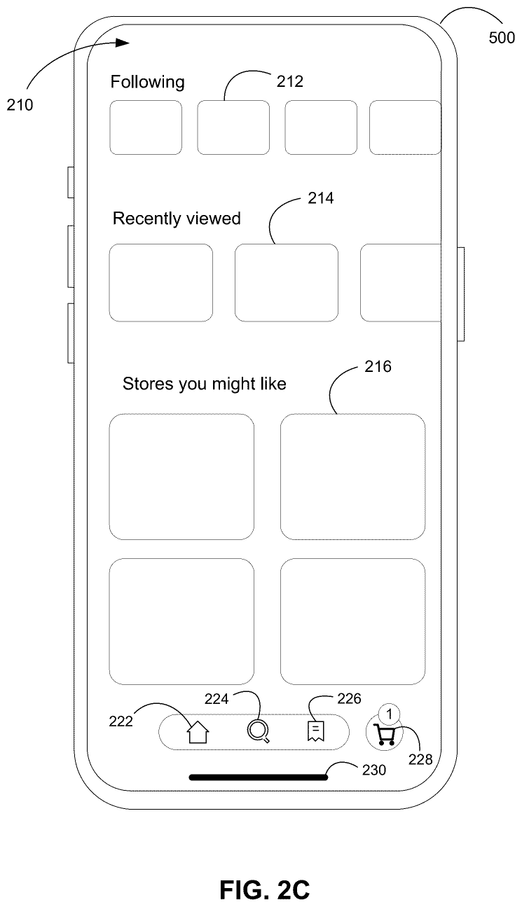

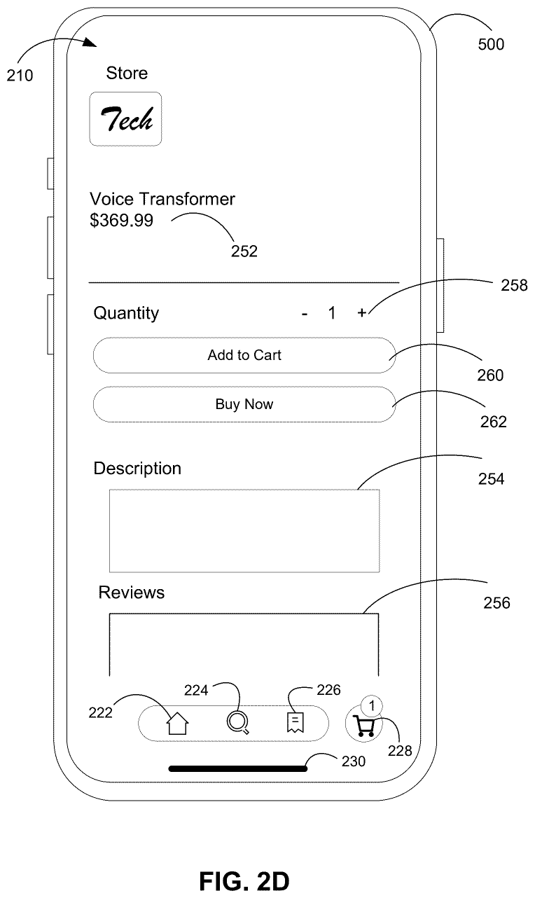

FIGS. 2A-2D illustrate examples of a GUI that is displayed by the computing system 500 (e.g., by executing the GUI module 560) and showing examples of the interactions with a virtual shopping cart view as disclosed herein. In the examples shown, a simplified GUI is displayed on a touchscreen of the computing system 500. The GUI may occupy the entire display area of the touchscreen.

FIG. 2A shows an example in which a virtual shopping cart view 240 is fully shown (e.g., occupies the full area of the GUI). The virtual shopping cart view 240 shows the contents of a virtual shopping cart 246 associated with an online store, including a list of products selected to be purchased from the online store and associated prices. Other information associated with the virtual shopping cart 246 (e.g., name of the associated online store) may be displayed on the virtual shopping cart view 240. In this example, a subtotal 244 associated with the virtual shopping cart 246 is shown as well as a checkout button 242 for initiating a checkout for that virtual shopping cart 246. As previously mentioned, the data for rendering the virtual shopping cart view 240, including the data for rendering the contents of the virtual shopping cart 246, may be maintained in a virtual shopping cart view data object 550 locally stored on the computing system 500. Thus, no data may need to be fetched or loaded from a remote server or other remote computing system external to the computing system 500 at the time that a user wishes to view the virtual shopping cart view 240.

It may be noted that when the virtual shopping cart view 240 is fully revealed, an edge region of an active view 210 is shown partially overlaid over a side of the virtual shopping cart view 240. The active view 210 is a view that the user may have been viewing prior to viewing the virtual shopping cart view 240. For example, the active view 210 may be a home view, a wishlist view, a product view, an online store view, etc. The state of the active view 210 may be unchanged by the user interacting with the GUI to view the virtual shopping cart view 240, such that the active view 210 may not need to be reloaded or re-rendered when the user switches back to the active view 210.

In some examples, multiple virtual shopping carts 246 may be shown on the virtual shopping cart view 240, for example different virtual shopping carts 246 may be associated with different online stores. The data for each virtual shopping cart 246 may be stored in a respective virtual shopping cart data object nested within the virtual shopping cart view data object 550. Each virtual shopping cart 246 may be displayed with its corresponding content, such as a corresponding product list, subtotal 244 and checkout button 242. In such embodiments, when the virtual shopping cart view 240 is shown, the virtual shopping cart view 240 may automatically scroll to the virtual shopping cart 246 corresponding to the active view 210. For example, if the active view 210 is a view of a given online store or a product view for a product purchasable from a given online store, then the virtual shopping cart view 240 may automatically scroll to show the virtual shopping cart 246 for that given online store. Other virtual shopping carts 246 for other online stores may be collapsed or decreased in size (e.g., by removal of images, removal of extra text, etc.); a collapsed or shrunken virtual shopping cart 246 may be expanded when an interactive element (e.g., a+icon) is selected.

A handle 230 is shown in the edge portion of the active view 210. The handle 230 may be interacted with using a drag gesture. For example, a drag gesture (e.g., initiated by a user's finger) may be used to select and drag the handle 230 away from the side of the GUI (in this example, downwards) to gradually hide the virtual shopping cart view 240 underneath the active view 210. The edge portion of the active view 210 may include some indication of the contents of the active view 210 (e.g., a faint image of the contents of the active view 210, a name of the active view 210, etc.), which may indicate to the user that the active view 210 is still active and accessible by interacting with the handle 230.

In this example, when the virtual shopping cart view 240 is fully revealed, a close option 248 (e.g., provided as an X icon) may be displayed. Selection of the close option 248 may automatically hide the virtual shopping cart view 240 under the active view 210. This may involve an animation of the active view 210 sliding to fully hide the virtual shopping cart view 240, or may be a switch from the virtual shopping cart view 240 to the active view 210 without this animation. In some example mobile implementations, the close option 248 may be provided at a region easily accessible by a thumb of a user (while holding the computing system 500 in a one-handed pose), to enable the user to quickly return to the active view 210, without having to interact with the handle 230 (which may now be out of reach of the thumb).

Various interactions, such as those discussed below (e.g., drag gesture, swipe gesture, etc.), may be used on the handle 230 to gradually slide the active view 210 to partially or fully hide the virtual shopping cart view 240.

As shown in FIG. 2B, a drag gesture (indicated by arrow) is detected at the handle 230. For example, a drag gesture may be performed by a user's finger 10 (the user's hand is not shown). The drag gesture moves away from the side of the GUI and causes the active view 210 (in this case, a home view) to be slid downwards, gradually hiding the virtual shopping cart view 240 underneath. In this example, when the virtual shopping cart view 240 is partially revealed (or equivalently partially hidden), the virtual shopping cart view 240 may be automatically scrolled such that higher priority information (e.g., checkout button 242, subtotal 244) is shown while lower priority information is hidden.

The contents of the active view 210 may be gradually displayed as the active view 210 is slid over the virtual shopping cart view 240. Since the active view 210 remained active (viewing the virtual shopping cart view 240 did not change the state of the active view 210 nor was the virtual shopping cart view 240 rendered to replace the active view 210), gradually displaying the contents of the active view 210 in this manner does not require additional computing resources to render the active view 210. In this example, the active view 210 includes a selectable home icon 222, a search icon 224, a wishlist icon 226 and a cart icon 228, which are discussed further below with respect to FIG. 2C.

In some examples, the virtual shopping cart view 240 may be visually distinct from the active view, for example by the virtual shopping cart view 240 having a dark background while the active view 210 has a white background (or vice versa), to create a sense that the virtual shopping cart view 240 is a layer underneath the active view 210. Other ways of visually distinguishing the virtual shopping cart view 240 from the active view 210 may be used.

The present disclosure encompasses various ways of interacting with the handle 230 to reveal the virtual shopping cart view 240. For example, a drag gesture can hide (or equivalently reveal) the virtual shopping cart view 240 partially (e.g., as shown in FIG. 2B). Release of the drag gesture may automatically slide the active view 210 back up to fully reveal the virtual shopping cart view 240 (e.g., automatically return to the virtual shopping cart view 240 as shown in FIG. 2A) if the handle 230 has been dragged less than a threshold distance (e.g., less than halfway across the GUI). In some examples, if the handle 230 has been dragged more than the threshold distance (e.g., more than halfway across the GUI), the GUI may automatically continue sliding down the active view 210 to fully hide the virtual shopping cart view 240 even if the handle 230 is not fully dragged to the opposite side of the GUI. This may provide the user with an intuitive sense that the active view 210 is being pulled over a “hill”, where if the active view 210 is not pulled over the top of the “hill” then the active view 210 will fall back down and reveal the virtual shopping cart view 240 again; and if the active view 210 is pulled over the top then the active view 210 will continue falling down the other side and fully hide the virtual shopping cart view 240.

In some examples, if a drag gesture is used to interact with the handle 230 and the virtual shopping cart view 240 is only partially hidden when the drag gesture is released, the position of the active view 210 may remain, regardless of the distance that the handle 230 has been dragged. This may provide the user with an intuitive sense that the active view 210 behaves like a sliding window that can be pulled down any desired amount over the virtual shopping cart view 240. Another drag gesture may be performed on the handle 230 to slide the active view 210 down to fully hide the virtual shopping cart view 240 or to slide the active view 210 up to fully reveal the virtual shopping cart view 240.

In some examples, if a drag gesture is used to interact with the handle 230 to partially hide the virtual shopping cart view 240 and a press gesture or double-tap gesture is used at the end of the drag gesture, this may cause the active view 210 to remain in place to keep the partial reveal of the virtual shopping cart view 240. This may provide the user with an intuitive sense that the active view 210 is being pinned in place. Another drag gesture may be performed on the handle 230 to slide the active view 210 down to fully hide the virtual shopping cart view 240 or to slide the active view up to fully reveal the virtual shopping cart view 240.

In some examples, if the interaction with the handle 230 is a swipe gesture, the active view 210 may be slid over the virtual shopping cart view 240 in a manner that mimics a physical push or pull action. For example, the animation of the active view 210 may continue to slide the active view 210 down after the swipe gesture is released (e.g., continuing at the speed of the swipe gesture at the end of the gesture and/or gradually slowing to mimic the effect of friction). This may mimic the effect of inertia when a physical object is pushed with significant force, for example.

In some examples, if the interaction with the handle 230 is a swipe gesture that exceeds a defined speed threshold or a defined acceleration threshold, the active view 210 may be automatically slid to fully hide the virtual shopping cart view 240, even after the swipe gesture is released.

In FIG. 2C, the GUI presents the active view 210 (e.g., a home view) fully hiding the virtual shopping cart view 240 underneath the active view 210. The home view in this example includes icons 212 of channels (e.g., online stores, event streams, etc.) the user has selected (e.g., the user has chosen to “follow” such channels to receive updates), icons 214 of recently viewed purchasable products (e.g., products for which the user has “recently viewed” the product view), and icons 216 of recommended stores (e.g., a recommendation engine may generate or predict “stores you might like”based on the user's recent purchases).

The active view 210 in this example includes a selectable home icon 222, a search icon 224, a wishlist icon 226 and a cart icon 228. The icons 222, 224, 226 and 228 may be located in an anchor region of the active view 210, for example. The home icon 222 may be selectable to navigate to the home view; the search icon 224 may be selectable to navigate to a search view; and the wishlist icon 226 may be selectable to navigate to a wishlist view. The cart icon 228 may be selectable (e.g., using a tap gesture) to fully reveal the virtual shopping cart view underneath the active view 210 (e.g., immediately returning to FIG. 2A). Optionally, animation (such as sliding, rolling, flipping, etc.) of the active view 210 transitioning to the virtual shopping cart view 240 can be shown when the cart icon 228 is selected (e.g., the view transitions from the example shown in FIG. 2C, back to FIG. 2B, back to FIG. 2A), which may indicate to the user that the virtual shopping cart view 240 is a view underneath and coexisting with the active view 210. Such animation may also help to guide the user to gestures (such as those disclosed herein) to transition between viewing the virtual shopping cart view 240 and the active view 210.

Various interactions, such as those discussed above (e.g., drag gesture, swipe gesture, etc.), may be used on the handle 230 to gradually slide the active view 210 to partially or fully reveal the virtual shopping cart view 240 (e.g., returning to the example GUIs illustrated in FIG. 2B or FIG. 2A). It should be understood that the various interactions described above may be equivalently performed in the reverse.

For example, a drag gesture on the handle 230 (e.g., upwards) can reveal the virtual shopping cart view 240 partially (e.g., as shown in FIG. 2B). Release of the drag gesture may automatically slide the active view 210 back down to fully hide the virtual shopping cart view 240 if the handle 230 has been dragged less than a threshold distance (e.g., less than halfway across the GUI). In some examples, if the handle 230 has been dragged more than the threshold distance (e.g., more than halfway across the GUI), the GUI may automatically continue sliding up the active view 210 to fully hide the virtual shopping cart view 240 even if the handle 230 is not fully dragged to the opposite side of the GUI. In some examples the virtual shopping cart view 240 may remain partially revealed and the position of the active view 210 may remain when the drag gesture is released, regardless of the distance that the handle 230 has been dragged. In some examples, a press gesture or double-tap gesture used at the end of the drag gesture may cause the active view 210 to remain in place to keep the partial reveal of the virtual shopping cart view 240.

In some examples, if the interaction with the handle 230 is a swipe gesture, the active view 210 may be slid up to fully reveal the virtual shopping cart view 240 in a manner that mimics a the inertia caused by a physical push or pull action (e.g., the active view 210 continues to slide up at the speed of the swipe gesture at the end of the gesture and/or gradually slowing to mimic the effect of friction). In some examples, if the swipe gesture exceeds a defined speed threshold or a defined acceleration threshold, the active view 210 may be automatically slid to fully reveal the virtual shopping cart view 240, even after the swipe gesture is released.

Using a drag gesture on the handle 230 to partially reveal the virtual shopping cart view 240 underneath the active view 210 may enable the GUI to provide a preview or “peek” of the contents of the virtual shopping cart view 240. When the virtual shopping cart view 240 is partially revealed, higher priority information may be shown while lower priority information may remain hidden. As shown in the example of FIG. 2B, a partially revealed virtual shopping cart view 240 may display high priority information such as the subtotal 244 and the checkout button 242. In some examples, higher priority information may include information about a product that was recently added to a virtual shopping cart, information about a product from an online store that was most recently viewed, etc.

In some examples, the information shown in the partially revealed virtual shopping cart view 240 may include images and/or text representing product(s) that have been added to a virtual shopping cart (e.g., in addition to or instead of the higher priority information described above). The images and/or text may be dynamically sized based on the revealed area of the virtual shopping cart view 240 (e.g., initially only small thumbnail images are shown, then as more of the virtual shopping cart view 240 is revealed the images may increase in size, and then when even more of the virtual shopping cart view 240 is revealed text descriptors may be shown with the images, etc.).

Release of the drag gesture without dragging the handle 230 the threshold distance (e.g., the handle 230 is moved less than half the length of the GUI) may automatically cause the virtual shopping cart view 240 to be hidden (and thus closing the preview). This may provide an advantageous mechanism to enable a user to quickly view the contents of the virtual shopping cart, without having to fully reveal the virtual shopping cart view 240.

In the example of FIG. 2C, each icon 214 showing a recently viewed product may be a selectable element that, when selected, causes the product view for that product to become the active view 210. In some examples, a drag gesture can be used to interact with an icon 214 to drag the icon 214 to the cart icon 228 or handle 230, which causes the product represented by that icon 214 to be added to the virtual shopping cart view 240. When dragged to the cart icon 228 or handle 230, the virtual shopping cart view 240 can be automatically partially revealed to display the updated virtual shopping cart view 240 with the product added. The virtual shopping cart view 240 can be fully hidden again automatically after a defined amount of time (e.g., after 1 s).

When the icon 214 is dragged to the cart icon 228 or handle 230 to add the associated product to the virtual shopping cart view 240, The virtual shopping cart view data object 550 is updated with the associated product information (e.g., product name, price, etc.). This means that the virtual shopping cart view 240 is updated with the added product and fully rendered underneath the active view 210 at the time that the product is added to the virtual shopping cart, so that the virtual shopping cart view 240 can be viewable with the updated information any time and from any active view 210, without having to fetch the data for rendering the virtual shopping cart view 240 at some later time that the user wishes to view the virtual shopping cart view 240.

In some examples, a pinch gesture may be performed on the active view 210 to cause the active view to shrink in size revealing the virtual shopping cart view 240 underneath. The active view 210 may return to its full size and fully hide the virtual shopping cart view 240 when the pinch gesture is released. Advantageously, this may enable the user to quickly take a look at the virtual shopping cart view 240 and quickly return to the active view 210, using only one simple gesture.

Reference is now made to FIG. 2D. In this example, the active view 210 is a product view fully hiding the virtual shopping cart view 240 underneath. The product view in this example includes information about a product (e.g., a voice transformer in this example), such as a price 252, a product description 254 and product reviews 256. The product view includes an option 258 to select a quantity of the product, an option 260 to add the product to the virtual shopping cart, and an option 262 to automatically initiate a checkout to purchase the product. The GUI also includes the home icon 222, search icon 224, wishlist icon 226, cart icon 228 and handle 230 as previously described. Selection of the option 260 to add the product to the virtual shopping cart causes the virtual shopping cart view data object 550 to be updated to include data for the product. Selection of the option 260 may also automatically cause the virtual shopping cart view 240 to be partially revealed, to confirm that the product has been added.

Although the handle 230 is illustrated towards a bottom of the active view 210 in the examples shown, it should be understood that the handle 230 may be provided near any side of the active view 210, such as the bottom, top, left or right sides. Further, although the handle 230 and cart icon 228 are illustrated as separate elements in this example, in other examples the cart icon 228 may be combined with the handle 230, for example the handle 230 may include or may be an icon such as a picture of a cart that can accept both a tap gesture (to fully reveal the virtual shopping cart view) and a drag gesture (to reveal the virtual shopping cart view by sliding away the active view). For mobile implementations, it may be useful for the cart icon 228 and/or handle 230 to be located towards the lower region of the GUI, for easier one-handed access, however this is not intended to be limiting. In some examples, the GUI may not include the handle 230. Instead, an interaction with the side region of the active view may be processed similarly to the various interactions with the handle 230 as described above (e.g., a drag gesture performed to drag up the bottom of the active view, in absence of any handle, may be processed similarly to a drag gesture performed to drag a handle 230 located near the bottom of the active view).

It should be understood that the various interactions described above in the context of touch-based gestures (e.g., drag gesture, swipe gesture, pinch gesture, tap gesture, etc.) may be similarly implemented using equivalent mouse gestures (e.g., using mouse gestures equivalent to the touch gestures, as previously discussed). Thus, although examples have been described and shown in the context of a mobile implementation having a touchscreen, the present disclosure may also be implemented in the context of a desktop or laptop implementing using mouse-based inputs.

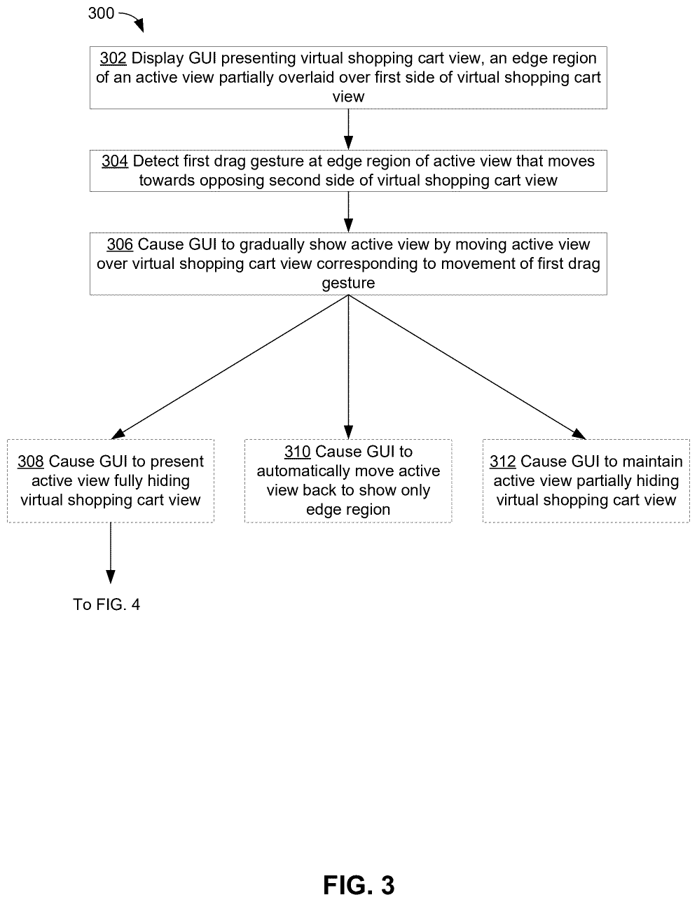

FIG. 3 is a flowchart of an example method 300 for an example embodiment of the present disclosure, which may be performed by a computing system (e.g., a computing system 500, which may be a handheld mobile device, a desktop device, a laptop device, etc.), in accordance with examples of the present disclosure. For example, a processing unit of a computing system (e.g., the processor 502 of the computing system 500 of FIG. 1) may execute instructions (e.g., the GUI module 560) to cause the computing system to carry out the example method 300.

At an operation 302, the computing system displays a GUI presenting a virtual shopping cart view, with an edge region of an active view partially overlaid over a first side of the virtual shopping cart view (e.g., as shown in FIG. 2A). The virtual shopping cart view may be rendered using data from a virtual shopping cart view data object stored locally on the computing system, as discussed above. In some examples, multiple virtual shopping carts may be presented on the virtual shopping cart view.

At an operation 304, a first drag gesture is detected at the edge region of the active view that moves towards an opposing second side of the virtual shopping cart view. In some examples, the first drag gesture may be detected at a handle UI element presented at the edge region of the active view. The active view may be, without limitation, a home view, a search view, a wishlist view, a product view or an online store view.

At an operation 306, the GUI is caused to gradually show the active view by moving the active view over the virtual shopping cart view corresponding to movement of the first drag gesture. From the operation 306, the method 300 may optionally proceed to an operation 308, operation 310 or operation 312.

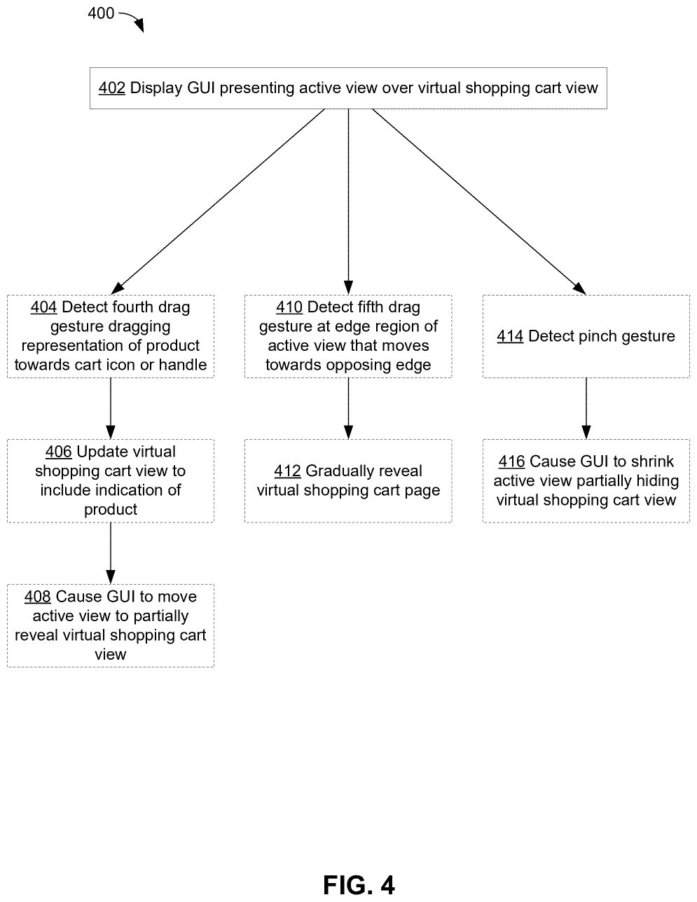

From the operation 306, if the first drag gesture moves at least a threshold distance from the first side to the second side of the virtual shopping cart view (e.g., at least halfway across the virtual shopping cart view), then the method 300 may proceed to the operation 308 to cause the GUI to present the active view fully hiding the virtual shopping cart view. From the operation 308, the method 300 may proceed to the method 400 shown in FIG. 4.

From the operation 306, if the first drag gesture moves less than a threshold distance from the first side to the second side of the virtual shopping cart view (e.g., less than halfway across the virtual shopping cart view), then the method 300 may proceed to the operation 310 to cause the GUI to automatically move the active view back to show only the edge region after release of the first drag gesture. The method 300 may return to the operation 302.

Alternatively, from the operation 306, if the first drag gesture moves less than a threshold distance from the first side to the second side of the virtual shopping cart view (e.g., less than halfway across the virtual shopping cart view), then the method 300 may proceed to the operation 312 to cause the GUI to maintain the active view partially hiding the virtual shopping cart view.

Alternatively, from the operation 306, if the first drag gesture moves less than a threshold distance from the first side to the second side of the virtual shopping cart view (e.g., less than halfway across the virtual shopping cart view) and a second touch input (e.g., a press gesture or a double-tap gesture) is detected at the end of the first drag gesture, then the method 300 may proceed to the operation 312 to cause the GUI to maintain the active view partially hiding the virtual shopping cart view.

From the operation 306, if the first drag gesture is a swipe gesture or transitions to a swipe gesture, then the method 300 may cause the GUI to continue moving the active view, even after release of the swipe gesture. This may cause the active view to fully hide the virtual shopping cart view.

During any time when the virtual shopping cart view is partially hidden (e.g., during transition from the full virtual shopping cart view to the full active view (or vice versa), or when the active view is maintained in place partially hiding the virtual shopping cart view), higher priority information on the virtual shopping cart view may be shown and lower priority information on the virtual shopping cart view may be hidden. For example, a subtotal amount and checkout option may be higher priority information. In another example, information about a product most recently added to a virtual shopping cart may be higher priority information. In another example, information about a product purchasable from a most recently viewed online store may be higher priority information.

At the operation 312, further interactions with the edge region (e.g., interactions with a handle UI element presented at the edge region) of the active view may cause the method 300 to proceed to the operation 308 or return to the operation 302. For example, a drag gesture performed at the edge region when the active view partially hides the virtual shopping cart view may cause the active view to slide away, once again fully revealing the virtual shopping cart view; or the opposite drag gesture may cause the active view to slide over, further hiding the virtual shopping cart view until the virtual shopping cart view is fully hidden.

FIG. 4 is a flowchart of an example method 400 for another example embodiment of the present disclosure, which may be performed by a computing system (e.g., a computing system 500, which may be a handheld mobile device, a desktop device, a laptop device, etc.), in accordance with examples of the present disclosure. For example, a processing unit of a computing system (e.g., the processor 502 of the computing system 500 of FIG. 1) may execute instructions (e.g., the GUI module 560) to cause the computing system to carry out the example method 400. In some examples, the method 400 may proceed from the method 300 as discussed above.

At an operation 402, the computing system displays a GUI presenting an active view over a virtual shopping cart view (e.g., fully hiding the virtual shopping cart view). The active view may be, without limitation, a home view, a search view, a wishlist view, a product view or an online store view. From the operation 402, the method 400 may optionally proceed to the operation 302 of the method 300, to an operation 404, operation 410 or operation 414.

In some examples, at the operation 402 while presenting the active view over the virtual shopping cart view, the GUI may include an icon (e.g., a cart icon) representing the virtual shopping cart view. If a third touch input (e.g., a tap gesture) is detected at the location corresponding to this icon, the GUI may be caused to fully reveal the virtual shopping cart (e.g., return to the operation 302 of the method 300). If the virtual shopping cart view includes information associated with multiple virtual shopping carts, the GUI may be caused to automatically scroll the presented virtual shopping cart view to a particular virtual shopping cart corresponding to the active view. For example, if the active view is a particular online store view, then tapping a cart icon may automatically fully reveal the virtual shopping cart view and automatically scroll the virtual shopping cart view such that the virtual shopping cart for that particular online store view is presented.

In some examples, the operation 402 may proceed to the operation 404. At an operation 404, a fourth drag gesture may be detected on the touchscreen at a location corresponding to a visual representation of a purchasable product (e.g., an image or icon representing a product) that moves (or drags) the visual representation towards an icon or a handle UI element of the GUI that is representative of the virtual shopping cart view.

At an operation 406, the virtual shopping cart view is updated to include an indication of the purchasable product (e.g., include information such as product image, product name, product price, quantity selected to purchase, etc.). Updating the virtual shopping cart view may involve updating a virtual shopping cart view data object to include data associated with the purchasable product. The virtual shopping cart view data object may be updated to include data that is renderable (e.g., image data, UI data, etc.) to show the indication of the purchasable product.

At an operation 408, the GUI may be caused to move the active view to partially reveal the virtual shopping cart view. The virtual shopping cart view may be partially revealed to present a portion of the virtual shopping cart view corresponding to the indication of the purchasable product (e.g., to show the product image added to the virtual shopping cart view). The partially revealed virtual shopping cart view may be automatically hidden after a defined period of time (e.g., after 1 s), and the method 400 may return to the operation 402.

In some examples, the operation 402 may proceed to the operation 410. At the operation 410, a fifth drag gesture may be detected on the touchscreen at a location corresponding to the edge region of the active view, where the fifth drag gesture moves towards an opposing edge of the active view.

At an operation 412, the GUI is caused to gradually reveal the virtual shopping cart view by moving the active view away from the virtual shopping cart view corresponding to movement of the fifth drag gesture. Although not shown in FIG. 4, it should be noted that various manners of interacting with the edge region of the active view may be supported from the operation 412, similar to the interactions describes previously with respect to the operations 306-312.

For example, if the fifth drag gesture moves at least a threshold distance towards the opposing edge of the active view, the virtual shopping cart view may become fully revealed with only the edge region of the active view remaining visible (e.g., return to the operation 302 of the method 300). If the fifth drag gesture instead moves less than the threshold distance the active view back may automatically move back to fully hide the virtual shopping cart view after release of the first drag gesture (e.g., return to the operation 402), or alternatively the active view may remain in place with the virtual shopping cart view partially revealed. Alternatively, if the fifth drag gesture moves less than the threshold distance and another touch input such as a press gesture or double-tap gesture is performed at the end of the fifth drag gesture, the active view may remain in place with the virtual shopping cart view partially revealed. If the fifth drag gesture is a swipe gesture or transitions to a swipe gesture, then the active view may be automatically slid away to fully reveal the virtual shopping cart view (e.g., return to the operation 302 of the method 300) even after release of the swipe gesture.

In some examples, the operation 402 may proceed to the operation 414. At the operation 414, a sixth touch input, namely a pinch gesture, is detected on the touchscreen.

At an operation 416, the GUI may be caused to shrink the active view to reveal the virtual shopping cart view underneath. Release of the pinch gesture may automatically return the active view to its full size, fully hiding the virtual shopping cart view underneath (e.g., returning to the operation 402).

Examples of the present disclosure may enable a user to navigate between an active view and a virtual shopping cart view, where the virtual shopping cart view is a persistent view underneath the active view. Examples of the present disclosure may be provided as an application that communicates with an e-commerce platform.

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

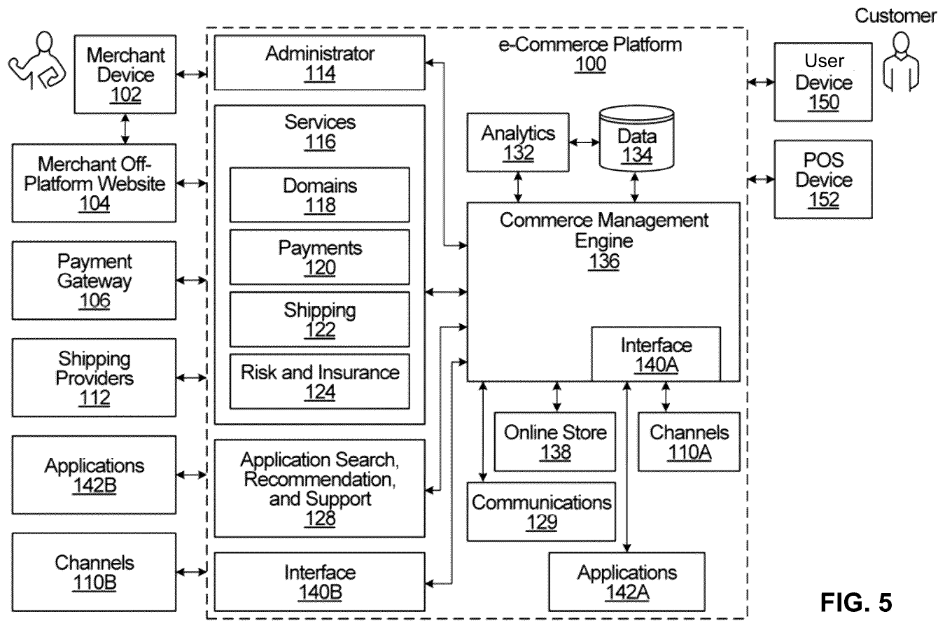

FIG. 5 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 5, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

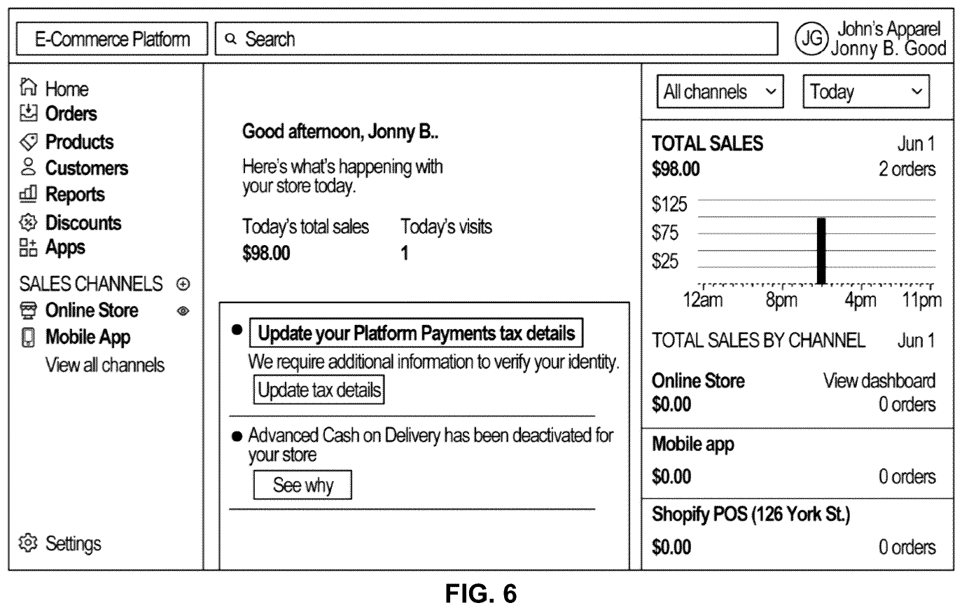

FIG. 6 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 6. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services, for example, in an analytics facility 132. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 5, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions / API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

Examples of the present disclosure may be provided via a customer-facing application 142A-B, for example. The GUI as disclosed herein may enable a user to interact with the e-commerce platform 100 (e.g., to select products to add to a virtual shopping cart) via the customer device 150 (which may be an embodied as the computing system 500 of FIG. 1).

Examples disclosed herein provide improvements to a user interface for interacting with a virtual shopping cart view that presents one or more virtual shopping carts. Intuitive gestures (including touch-based inputs such as drag gestures, swipe gestures, pinch gestures, tap gestures, etc.) are supported to enable the user to transition between an active view and the virtual shopping cart view, without requiring the user to navigate away from the active view. The data for rendering the virtual shopping cart view is maintained locally in a virtual shopping cart view data object, which is updated each time products are added to (or removed from) a virtual shopping cart. This enables the virtual shopping cart view to be rendered locally and already available to be viewed underneath the active page, without requiring data for the virtual shopping cart view to be fetched from a remote server at the time that the user wishes to view the virtual shopping cart view. This provides a technical advantage in that redundant navigation inputs can be avoided, and consumption of computer resources for repeatedly fetching and rendering the virtual shopping cart view and active view can be avoided.

Examples disclosed herein enable the virtual shopping cart view to be partially revealed while still viewing the active view, which provides a useful manner of displaying virtual shopping cart information. This provides a technical advantage in that relevant information (e.g., information about a newly added product, a subtotal, etc.) can be easily viewed by the user, without having to fully navigate away from the active view, thus avoiding unnecessary inputs and consumption of computer resources required to fetch and render the active view and virtual shopping cart view.

Examples disclosed herein may provide advantages particularly for implementation on handheld mobile devices, where screen size is small and where input options are limited. In such a device, typically only one view can be fully viewed at a time (e.g., one view fully occupies the area of the screen on the device), so being able to smoothly switch between the active view and virtual shopping cart view is important. Examples disclosed herein supports various gestures for transitioning between the active view and the virtual shopping cart view using a thumb when the handheld device is held in one hand, including being able to quickly slide between the two views by performing a dragging gesture using the thumb.

It should be understood that examples of the present disclosure may be implemented on non-handheld and/or non-mobile devices, such as a desktop device or a laptop device. Additionally, examples of the present disclosure may be implemented on any computing device having a display screen, including wearable devices (e.g., smartwatches). Although examples are described in the context of touch-based inputs, other input mechanisms (e.g., mouse-based inputs) may be used to implement the present disclosure.

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method performed by a computing system having a touchscreen, the method comprising:
displaying, on the touchscreen, a graphical user interface (GUI) presenting a virtual shopping cart view, the GUI also presenting an edge region of an active view partially overlaid over a first side of the virtual shopping cart view;
detecting a first drag gesture on the touchscreen at the edge region of the active view that moves towards an opposing second side of the virtual shopping cart view; and
responsive to the first drag gesture, cause the GUI to gradually show the active view by moving the active view over the virtual shopping cart view corresponding to movement of the first drag gesture.

2. The method of claim 1, wherein the virtual shopping cart view is rendered using data from a virtual shopping cart view data object stored locally on the computing system.

3. The method of claim 1, wherein a handle user interface (UI) element is presented in the edge region of the active view, and the first drag gesture is detected at the handle UI element.

4. The method of claim 1, wherein the first drag gesture moves at least a threshold distance from the first side to the second side of the virtual shopping cart view, and wherein the GUI presents the active view fully hiding the virtual shopping cart view responsive to the first drag gesture.

5. The method of claim 1, wherein the first drag gesture moves less than a threshold distance from the first side to the second side of the virtual shopping cart view, and wherein the GUI automatically moves the active view back to show only the edge region after release of the first drag gesture.

6. The method of claim 5, further comprising:
detecting a second touch input at an end of the first drag gesture; and
responsive to the second touch input, cause the GUI to maintain the active view partially presented over the virtual shopping cart view.

7. The method of claim 1, wherein the first drag gesture moves less than a threshold distance from the first side to the second side of the virtual shopping cart view, causing the active view to partially hide the virtual shopping cart view, and wherein the active view is maintained in place after release of the first drag gesture.

8. The method of claim 7, wherein when the virtual shopping cart view is partially hidden, higher priority information on the virtual shopping cart view is shown and lower priority information on the virtual shopping cart view is hidden.

9. The method of claim 1, further comprising:
while the GUI is presenting the active view over the virtual shopping cart view, detecting a third touch input on the touchscreen at a location corresponding to an icon of the GUI that is representative of the virtual shopping cart view; and
responsive to the third touch input, cause the GUI to present the virtual shopping cart view with the edge region of the active view partially overlaid over the first side of the virtual shopping cart view.

10. The method of claim 9, wherein the virtual shopping cart view includes information associated with multiple virtual shopping carts, and wherein the GUI is caused to automatically scroll the presented virtual shopping cart view to a particular virtual shopping cart corresponding to the active view.

11. The method of claim 1, further comprising:
while the GUI is presenting the active view over the virtual shopping cart view, detecting a fourth drag gesture on the touchscreen at a location corresponding to a visual representation of a purchasable product that moves towards an icon or a handle user interface (UI) element of the GUI that is representative of the virtual shopping cart view; and
responsive to the fourth drag gesture, updating the virtual shopping cart view to include an indication of the purchasable product and cause the GUI to move the active view to partially reveal the virtual shopping cart view.

12. The method of claim 11, wherein the virtual shopping cart view is partially revealed to present a portion of the virtual shopping cart view corresponding to the indication of the purchasable product.

13. The method of claim 11, wherein updating the virtual shopping cart view comprises:
updating a virtual shopping cart view data object to include data associated with the purchasable product that is renderable to show the indication of the purchasable product.

14. The method of claim 1, further comprising:
while the GUI is presenting the active view over the virtual shopping cart view, detecting a fifth drag gesture on the touchscreen at a location corresponding to the edge region of the active view that moves towards an opposing edge of the active view; and
responsive to the fifth drag gesture, cause the GUI to gradually reveal the virtual shopping cart view by moving the active view away from the virtual shopping cart view corresponding to movement of the fifth drag gesture.

15. The method of claim 14, wherein when the virtual shopping cart view is partially revealed, higher priority information on the virtual shopping cart view is shown and lower priority information on the virtual shopping cart view remains hidden.

16. The method of claim 1, further comprising:
while the GUI is presenting the active view over the virtual shopping cart view, detecting a sixth pinch gesture on the touchscreen; and
responsive to the sixth pinch gesture, cause the GUI to shrink the active view to reveal the virtual shopping cart view underneath.

17. The method of claim 1, wherein the active view is one of:
a home view;
a search view;
a product view;
an online store view; or
a wishlist view.

18. A computing system comprising:
a processor configured to execute computer-readable instructions to cause the computing system to:
display, on a touchscreen of the computing system, a graphical user interface (GUI) presenting a virtual shopping cart view, the GUI also presenting an edge region of an active view partially overlaid over a first side of the virtual shopping cart view;
detecting a first drag gesture on the touchscreen at the edge region of the active view that moves towards an opposing second side of the virtual shopping cart view; and
responsive to the first drag gesture, cause the GUI to gradually show the active view by moving the active view over the virtual shopping cart view corresponding to movement of the first drag gesture.

19. The computing system of claim 18, wherein the virtual shopping cart view is rendered using data from a virtual shopping cart view data object stored locally on the computing system.

20. A non-transitory computer-readable medium storing instructions that, when executed by a processor of a computing system, cause the computing system to:
display, on a touchscreen of the computing system, a graphical user interface (GUI) presenting a virtual shopping cart view, the GUI also presenting an edge region of an active view partially overlaid over a first side of the virtual shopping cart view;
detecting a first drag gesture on the touchscreen at the edge region of the active view that moves towards an opposing second side of the virtual shopping cart view; and
responsive to the first drag gesture, cause the GUI to gradually show the active view by moving the active view over the virtual shopping cart view corresponding to movement of the first drag gesture.
